(19) United States
(12) Patent Application Publication
(10) Pub. No.: US 2014/0020653 A1
(43) Pub. Date: Jan. 23, 2014

(54) DIRECT FUEL INJECTION SYSTEM

(71) Applicants: Brad Alan VanDerWege, Plymouth, MI (US); Foo Chern Ting, Canton, MI (US); Jianwen James Yi, Canton, MI (US)

(72) Inventors: Brad Alan VanDerWege, Plymouth, MI (US); Foo Chern Ting, Canton, MI (US); Jianwen James Yi, Canton, MI (US)

(73) Assignee: FORD GLOBAL TECHNOLOGIES, LLC, Dearborn, MI (US)

(21) Appl. No.: 13/551,419

(22) Filed: Jul. 17, 2012

(51) Int. Cl. F02B 3/00

(52) U.S. Cl. 123/302; 123/294

(57) ABSTRACT

A system in an internal combustion engine is provided. The system a combustion chamber, a first exhaust port in fluidic communication with the combustion chamber, a second exhaust port in fluidic communication with the combustion chamber, and a direct fuel injector positioned between the first and second exhaust port and fluidly communicating directly with the combustion chamber.

### BACKGROUND/SUMMARY

Direct fuel injection systems are used in engines to deliver fuel directly into the combustion chamber. Direct fuel injection systems have several benefits such as providing increased precision in fuel metering and injection timing when compared to port fuel injection systems. As a result, combustion efficiency may be increased, thereby increasing fuel efficiency and/or power output of the engine.

However, direct injection systems may involve tradeoffs between air/fuel mixing, surface wetting, and injector temperature. The surface wetting may lead to increased emissions and oil dilution in the engine. Additionally, increasing the injector temperature may lead to injector coking. For example, direct injector tips may be positioned adjacent to an intake valve in the cylinder. To reduce the likelihood of wetting the intake valve, the spray pattern of the tip may be altered which may decrease the mixing of the fuel spray with the intake air, thereby decreasing combustion efficiency. Furthermore, under flash boiling conditions the fuel spray may still wet the intake valves. Additionally, the tumble charge motion in the combustion chamber may be increased when an intake side injector is used.

In other examples, central injectors may be utilized to increase mixing of the air/fuel in the combustion chamber. However, central injectors may have a higher tip temperature due to their proximity to burned gasses in the combustion chamber when compared to a direct injector positioned further from the spark plug. Higher tip temperatures may lead to increased coking and tip deposits, thereby increasing engine emissions (e.g., particle matter (PM) emissions).

To address at least some of the aforementioned issues, a system in an internal combustion engine is provided. The system comprises a combustion chamber, a first exhaust port in fluidic communication with the combustion chamber, a second exhaust port in fluidic communication with the combustion chamber, and a direct fuel injector positioned between the first and second exhaust port and fluidly communicating directly with the combustion chamber. In this way, the interaction between the fuel spray from the direct fuel injector and an intake valve may be greatly reduced. For example, when the direct fuel injector is placed between the exhaust ports, the likelihood of intake valve wetting is reduced, particularly during periods of flash boiling and certain injection and cam timing profiles. Yet, it is still possible to position the injector tip away from the peak temperature conditions, and also it is still possible to provide a desirable angle of injection into the cylinder.

Further still, positioning the direct fuel injector between exhaust ports may also increase the counter-flow between intake air entering the combustion chamber and the fuel spray from the injector, thereby reducing spray penetration and therefore surface wetting in the combustion chamber. Furthermore, unexpectedly, during low speed conditions the position of the direct fuel injector generates increased tumble charge motion in the combustion chamber and in a desirable direction which does not increase surface wetting. This location of the direct fuel injector also enables air-guided stratification for cold-start catalyst heating, thereby improving catalyst operation and reducing emissions during cold-starts.

In some examples, a width of an intake bridge section included in a cylinder head is less than a width of an exhaust bridge section included in the cylinder head, the exhaust bridge section extending between the first and second exhaust ports and the intake bridge section extending between a first intake port and a second intake port, the first and second intake ports in direct fluidic communication with the combustion chamber. The cylinder head may be constructed in this manner to accommodate for the exhaust side direct fuel injector.

Further in some examples, the piston crown may have its lowest point on an exhaust side of the combustion chamber. When the piston crown has these geometric characteristics, air-guided stratification for cold-start catalyst heating is further improved.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an internal combustion engine included in a vehicle; and

FIGS. 2-4 show an illustration of the internal combustion engine including a direct fuel injector shown in FIG. 1.

FIGS. 2-4 are drawn approximately to scale, although other relative dimensions may be used, if desired.

### DETAILED DESCRIPTION

A direct fuel injector extending between two exhaust ports and exhaust valves is described herein. The direct fuel injector is configured to generate a fuel spray in a direction that at least partially opposes the direction of intake air entering a combustion chamber through intake ports. When the direct fuel injector is positioned in such a manner, mixing of the fuel spray with the air is increased, enabling increased combustion efficiency and power output of the engine, while at the same time reducing the likelihood of intake valve wetting. Additionally, the direct fuel injector may increase tumble charge motion in the combustion chamber during some operating conditions, further increasing mixing.

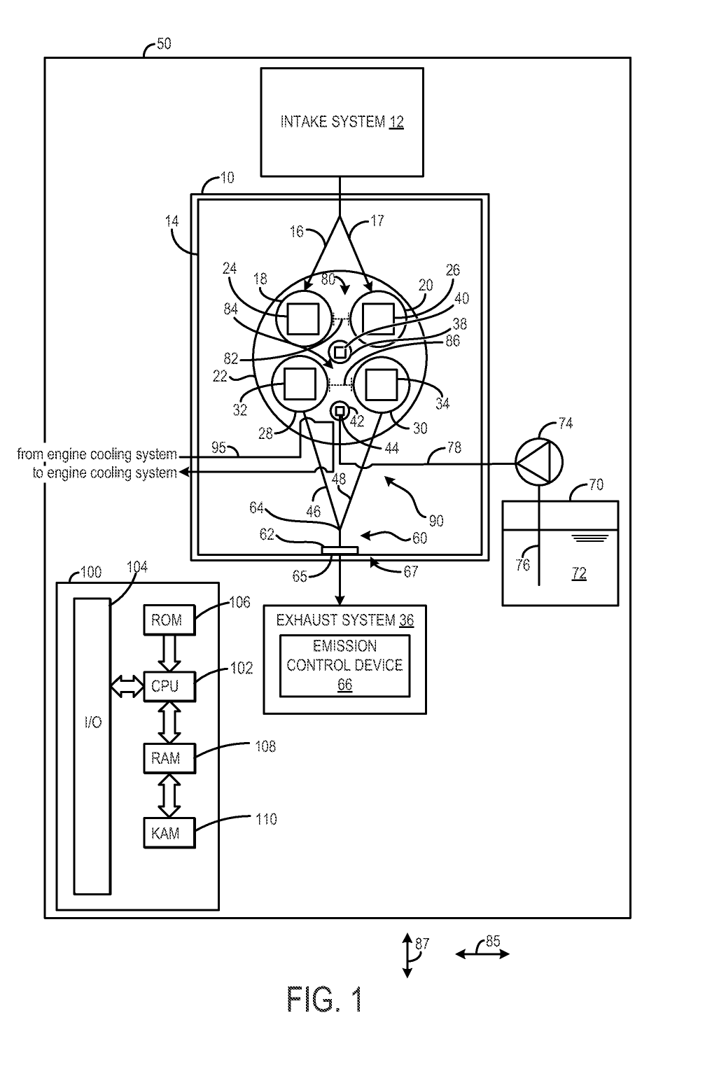

FIG. 1 shows a schematic depiction of an internal combustion engine 10 included in a vehicle 50. An intake system 12 is also included in the vehicle 50. The intake system 12 is configured to provide intake air to the engine 10.

The intake system 12 may include a throttle configured to adjust the flowrate of the intake air through the intake system 12. The intake system 12 may further include an intake manifold in fluidic communication with combustion chambers in the engine 10. In some examples, the intake manifold may be integrated into a cylinder head 14.

A first intake runner 16, denoted via an arrow, is in direct fluidic communication with a first intake port 18. Likewise, a second intake runner 17, denoted via an arrow, is in direct fluidic communication with a second intake port 20. Thus, air may flow through the intake air conduits into the engine 10. As shown, intake air may be provided to a first intake port 18 and a second intake port 20 included in the engine 10. The intake ports (18 and 20) are in direct fluidic communication with a combustion chamber 22 included in the engine. In direct fluidic communication means that the components are in fluidic communication (e.g., coupled together) with one another without any intervening components positioned therebetween.

A first intake valve 24, generically depicted via a box, may be positioned in the first intake port 18. Likewise, a second intake valve 26, generically depicted via a box, may be positioned in the second intake port 20.

The intake valves (24 and 26) are configured to selectively enable air to flow into the combustion chamber through their respectively intake port. Thus, the intake valves may each have at least an open position where air can flow through a respective intake port and a closed position in which intake air is substantially inhibited from flowing through the respective intake port. The intake valves (24 and 26) may be actuated via cams or via an electromagnetic system. It will be appreciated that the intake valves (24 and 26) may be cyclically actuated to perform combustion. The intake system 12 may include additional components that enable intake air delivery to the engine 10, such as a throttle, intake conduit, compressor, etc.

A first exhaust port 28 and a second exhaust port 30 are also included in the engine 10 and specifically the cylinder head 14. The first exhaust port 28 and the second exhaust port 30 are in direct fluidic communication with the combustion chamber 22. A first exhaust valve 32, generically depicted via a box, may be positioned in the first exhaust port 28. Likewise, a second exhaust valve 34, generically depicted via a box, may be positioned in the second exhaust port 30. The exhaust valves (32 and 34) are configured to selectively enable air to flow from the combustion chamber 22 to an exhaust system 36 through their respective exhaust ports. Thus, the exhaust valves may each have at least an open position where exhaust can flow through a respective exhaust port and a closed position in which exhaust is substantially inhibited from flowing through the respective exhaust port.

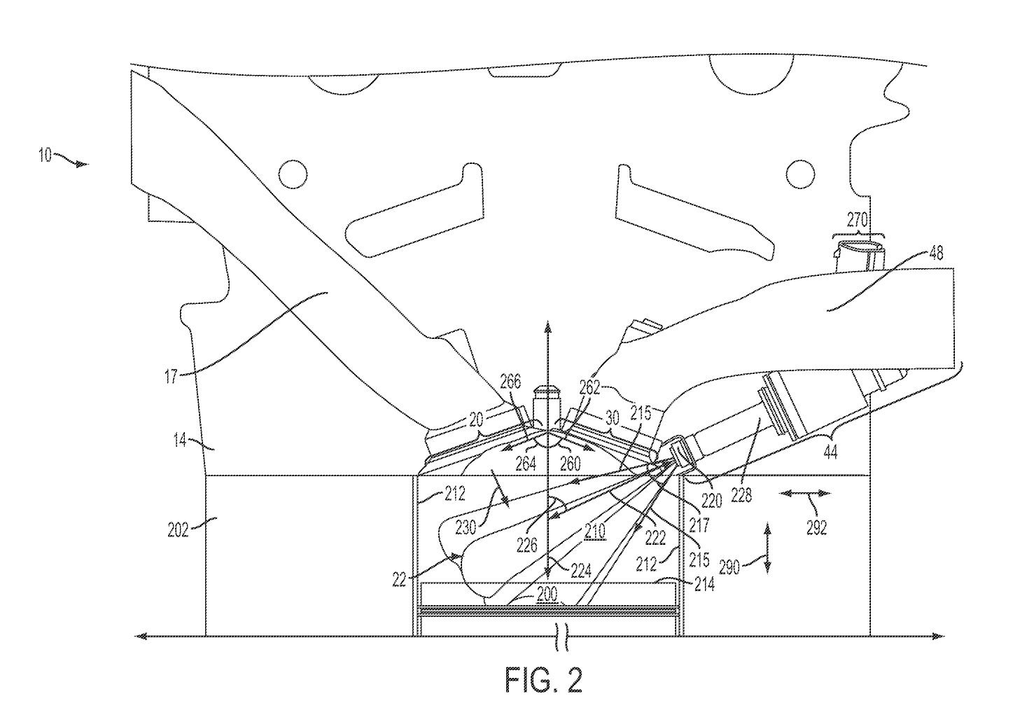

The engine 10 also includes a cylinder head 14. A cylinder block 202, shown in FIG. 2, is coupled to the cylinder head 14. When coupled, the cylinder head 14 and the cylinder block 202 form the combustion chamber 22.

The cylinder head 14 includes an ignition device port 38. An ignition device 40 (e.g., spark plug), generically depicted via a box, is positioned in the ignition device port 38. Thus, the ignition device port 38 receives the ignition device 40. The ignition device 40 is configured to provide an ignition spark to an air/fuel mixture in the combustion chamber 22. The ignition device port 38 and therefore the ignition device 40 are positioned between the intake ports (18 and 20) and the exhaust ports (28 and 30). Additionally or alternatively compression ignition may be utilized.

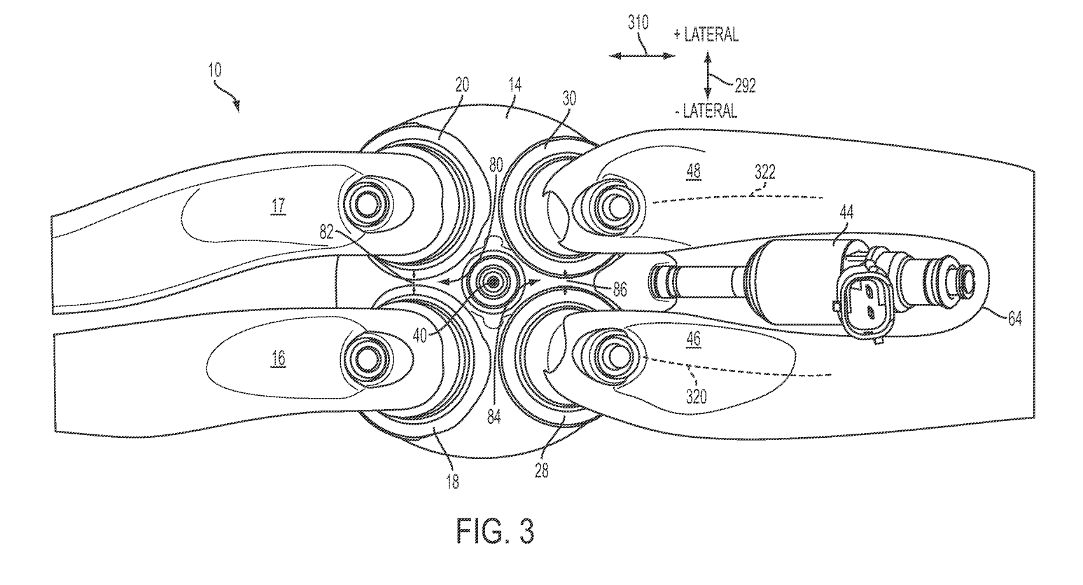

A fuel injector port 42 is also included in the cylinder head 14. A direct fuel injector 44, generically depicted via a box, included in the engine 10 extends through the fuel injector port 42 into the combustion chamber 22 to provide what is referred to as direct injection. In other words, the direct fuel injector 44 fluidly communicates directly with the combustion chamber 22. The direct fuel injector 44 is configured to spray fuel directly into the combustion chamber 22 at desired time intervals. A detailed illustration of the direction fuel injector 44 is shown in FIGS. 3-6 and described in greater detail herein.

The direct fuel injector 44 is in fluidic communication with a fuel tank 70 housing a fuel 72 such as gasoline, diesel, bio-diesel, alcohol, etc. A fuel pump 74 having a pick-up line 76 position in the fuel tank is included in the vehicle 50. A fuel line 78 connects the outlet of the fuel pump 74 to the direct fuel injector 44. In this way, fuel may be flowed from the fuel tank 70, through the pump 74, and through fuel line 78 to the direct fuel injector 44. It will be appreciated that a second fuel pump which may have a higher pressure than the first may be included in the vehicle 50.

As shown, the direct fuel injector 44 is positioned between the first exhaust port 28 and the second exhaust port 30 and therefore between the first exhaust valve 32 and the second exhaust valve 34. Thus, the direct fuel injector 44 interposes the first exhaust port 28 and the second exhaust port 30. Moreover, the direct fuel injection is positioned opposite to the first intake port 18 and the second intake port 20. Additionally, the direct fuel injector 44 aims a fuel spray at least partially toward and intake side of the combustion chamber 22.

It will be appreciated positioning the direct fuel injector 44 in this way may have a variety of benefits, such as decreasing wetting of the combustion chamber walls, intake valve, etc., via the fuel spray from the direct fuel injector, increasing air/fuel mixing in the combustion chamber, and decreasing the temperature of the injector. Specifically, when the direct fuel injector is positioned in this way the counter-flow between intake air entering the combustion chamber 22 and the fuel spray from the direct fuel injector is increased, thereby reducing spray penetration and therefore surface wetting in the combustion chamber and the intake valves. The counter-flow may also increase the mixing of the air and the fuel, increasing combustion efficiency. Furthermore, the temperature of the direct fuel injector 44 and specifically its outlet tip, may be within a desired range due to its distance from the ignition device 40. Furthermore, during low speed conditions the position of the direct fuel injector increases tumble charge motion. The location of the direct fuel injector also enables air-guided stratification for cold-start catalyst heating, thereby improving catalyst operation and reducing emissions during cold-starts.

The exhaust system 36 is in fluidic communication with the combustion chamber 22. A first exhaust runner 46, depicted via a line, is in direct fluidic communication with the first exhaust port 28 Likewise, a second exhaust runner 48, depicted via a line, is in direct fluidic communication with the second exhaust port 30.

The first and second exhaust runners (46 and 48) are integrated into the cylinder head 14 in the depicted embodiment. Specifically, the first and second exhaust runners (46 and 48) may be included in an exhaust manifold 60 integrated into the cylinder head 14. The integrated exhaust manifold 60 further includes an exhaust collector 62 positioned downstream of the confluence 64 of the first exhaust runner 46 and the second exhaust runner 48. It will be appreciated that the direct fuel injector 44 is positioned between the first and second exhaust runners (46 and 48) upstream of the confluence 64.

The exhaust manifold includes an outlet 65 positioned on an exhaust side 67 of the cylinder head 14. The outlet 65 may be coupled to an exhaust passage, turbine, emission control device, etc., included in the exhaust system 36. The outlet 65 is on fluidic communication with the exhaust system 36. The exhaust system 36 may include an emission control device 66 (e.g., a catalyst, particulate filter, etc). The exhaust system 36 may also include exhaust conduits for flowing exhaust gas to the surrounding environment. It will be appreciated that the exhaust system may include additional components that are not depicted, such additional emission control devices, a noise control device (e.g. a muffler), etc.

Controller 100 is shown in FIG. 1 as a conventional microcomputer including: microprocessor unit 102, input/output ports 104, read-only memory 106, random access memory 108, keep alive memory 110, and a conventional data bus. Controller 100 may send signals to the direct fuel injector 44 to adjust the injector. The signal may be configured to control the metering and timing of the fuel spray injected via the direct fuel injector 44. In this way, fuel delivery to the combustion chamber 22 via the direct fuel injector 44 may be controlled via the controller 100. The controller 100 may also provide a signal to the ignition device 40. Therefore, the controller 100 may be configured to adjust ignition timing in the engine 10.

It will be appreciated that the controller 100 may send additional signals to other components in the engine 10 and/or vehicle 50. Furthermore, the controller 100 may receive signals from various components in the vehicle 50 such as sensor (e.g., temperature sensors, pressure sensors, oxygen sensors, etc.)

The fuel injector 44, the intake ports (18 and 20), the intake valves (24 and 26), the exhaust ports (28 and 30), the exhaust valves (32 and 34), the combustion chamber 22, the exhaust manifold 60, the intake runner (16 and 17), cylinder head 14, and controller 100 may be included in a system 90. Additional parts that have not been mentioned may be included in the system 90, if desired. The system 90 may be a fuel injection system.

The cylinder head 14 includes an intake bridge section 80. The intake bridge section 80 extends between the first intake port 18 and the second intake port 20. A width 82 of the intake bridge section 80, in the lateral direction, is depicted. A lateral axis 85 and a longitudinal axis 87 are provided for reference. The cylinder head 14 also includes an exhaust bridge section 84. The exhaust bridge section 84 extends between the first exhaust port 28 and the second exhaust port 30. A width 86 of the exhaust bridge section 84, in the lateral direction, is depicted.

The width 86 of the exhaust bridge section 84 is greater than the width 82 of the intake bridge section 80 to accommodate for the direct fuel injector 44. However, in other embodiments the widths of the bridge sections may be equivalent or the width of the intake bridge section may be greater than the width of the exhaust bridge section. It will be appreciated that additional combustion chambers may be included in the engine 10 having similar valves, direct injectors, ignition devices, etc. Additionally, during operation, the combustion chamber 22 within engine 10 typically undergoes a four stroke cycle: the cycle includes the intake stroke, compression stroke, expansion stroke, and exhaust stroke.

FIG. 1 also shows a coolant passage 95. The coolant passage 95 traverses the cylinder head 14 adjacent to the injector port and therefore the injector. Additionally, the coolant passage 95 is also adjacent to the first exhaust port 28, thereby providing cooling to the exhaust port. An engine cooling system is configured to flow coolant through the coolant passage 95. Thus, the coolant passage 14 is in fluidic communication with the engine cooling system. The engine cooling may include a heat exchanger (not shown), a coolant pump (not shown), additional coolant passages (not shown), etc. The additional coolant passages may traverse other portions engine 10, such as the other portions of the cylinder head 14 and/or the cylinder block 202, shown in FIG. 2. The engine cooling system may be configured to remove heat from the cylinder head 14 and/or the cylinder block 202, shown in FIG. 2.

FIGS. 2-4 show an embodiment of an example engine 10 including the cylinder head 14, combustion chamber 22, and direct fuel injector 44. It will be appreciated that the direct fuel injector 44 shown in FIGS. 2-4 is in fluidic communication with the fuel tank 70, shown in FIG. 1. Specifically, FIG. 2 shows the direct fuel injector 44 spraying a fuel spray 210 into the combustion chamber 22 via a tip 220. The tip 220 may include a nozzle. The cylinder head 14 is shown coupled to a cylinder block 202 forming the combustion chamber 22 in FIG. 2. The second intake port 20, the second exhaust port 30, the second exhaust runner 48, and the second intake runner 17 are also illustrated. As previously discussed, the intake and exhaust ports are in fluidic communication with the combustion chamber 22. Combustion chamber walls 212 are also shown. The walls 212 and a crown 214 of the piston 200 define the boundary of the combustion chamber 22. It will be appreciated that the piston 200 is coupled to a crankshaft (not shown). The piston crown 214 may have its lowest point positioned on the exhaust side of the combustion chamber 22, in some embodiments.

The divergent angle 217 of the fuel spray 210 may be between 30 and 70 degrees. The divergent angle 217 is an angular measurement between lines 215 extending down the boundary of the fuel spray 210. Thus, the spray pattern diverges from the axis 222 by between 0 and 50 degrees on each side. In some examples, the spray pattern is asymmetric with regard to the injector axis.

An axis 222 of the tip 220 intersects the central axis 224 of the combustion chamber at a spray angle 226 of 62.5 degrees. However, other spray angles have been contemplated. In some examples, the angle spray 226 may be between 30 and 90 degrees or 45 and 80. It will be appreciated that the axis 222 of the tip 220 may not be aligned with the central axis of a delivery tube 228 in the direct fuel injector 44 in some embodiments.

Arrow 230 denotes the general flow of intake air through the second intake port 20 into the combustion chamber 22. It will be appreciated that the intake airflow has additional complexity that is not depicted. As illustrated the direction of the fuel spray 210 at least partially opposes the flow of intake air into the combustion chamber. As a result, mixing may of the fuel and air may be enhanced, thereby increasing combustion efficiency. Additionally, the direct fuel injector 44 is positioned vertically below the exhaust runner 48. However, other relative positions have been contemplated. A vertical axis 290 and a lateral axis 292 are provided for reference.

FIG. 2 also shows a first angle 260 formed between a radial axis 262 of the second exhaust port 30 and the central axis 224 of the combustion chamber 22 is less than a second angle between a radial axis of the second intake port 20 and the central axis 224. FIG. 2 also shows a second angle 264 formed between a radial axis 266 of the second intake port 20 and the central axis 224. The first angle 260 is less than the second angle 264, in the depicted embodiment. However, in other embodiments the first angle may be greater than the second angle or the two angles may be equivalent. The radial axis 262 of the second exhaust port 30 is perpendicular to and extends through an axial aligned axis of the second exhaust port. Likewise, the radial axis 266 is perpendicular to and extends through an axial aligned axis of the second intake port 20. It will be appreciated that the first and second intake ports have similar geometries and angles. Likewise, the first and second exhaust ports have similar geometries and angles. A plane extending into and out of the drawing sheet (i.e., perpendicular to drawing sheet) and through the central axis 224 may be the dividing line between the exhaust side and the intake side of the combustion chamber 22. As shown, an electrical connector 270 included in the direct fuel injector 44 vertically extends from the direct fuel injector. The electrical connector 270 may be configured to receive signals from the controller 100 via a wired or wireless electrical connection. In other embodiments, the electrical connector 270 may extend in a different direction such as downward towards the cylinder block 202.

FIG. 3 shows a top view of the engine 10 including the cylinder head 14. The first intake runner 16 and the second intake runner 17 are shown. Additionally, the first intake port 18 and the second intake port 20 are also illustrated. The ignition device 40 is also shown. The first exhaust port 28 and the second exhaust port 30 are also shown. Additionally, the first exhaust runner 46 and the second exhaust runner 48 are depicted. The direct fuel injector 44 is shown extending between the first exhaust runner 46 and the second exhaust runner 48. In this way, the compactness of the cylinder head 14 may be increased. However, other fuel injector positions have been contemplated. It will be appreciated that the first exhaust runner 46 and the second exhaust runner 48 are integrated into the cylinder head 14 in the depicted embodiment. This integration increases the compactness of the engine 10. The width 82 of the intake bridge section 80 is also depicted. Additionally, the width 86 of the exhaust bridge section 84 is also shown.

As shown, the first exhaust runner 46 and the second exhaust runner 48 converge at the confluence 64 of the two runners have an unequal length to accommodate for the direct fuel injector 44. The length of the first exhaust runner 46 may be measured along a runner axis 320 from the first exhaust runner's interface with the first exhaust port 28 to the confluence 64. Thus, the end of the exhaust runners may be at the confluence 64. It will be appreciated that exhaust passages may continue downstream to the outlet of the exhaust manifold. The length of the second exhaust runner 48 may be measured from its interface with the second exhaust port 30 and the confluence 64. The length of the second exhaust runner 48 may be measured along a runner axis 322 from the second exhaust runner's interface with the second exhaust port 30 to the confluence 64. The runner axes 320 and 320 may be the central axes of their respective exhaust runner. Thus, the end of the exhaust runners may be at the confluence 64. The second exhaust runner 48 is longer than the first exhaust runner 46, in the depicted embodiment. However, in other embodiments the first and second exhaust runners may have an equivalent length or the first exhaust runner may have a greater length than the second exhaust runner.

Furthermore, the first exhaust runner 46 and the second exhaust runner 48 are curved. The curvatures of the exhaust runners oppose one another. Specifically, the exhaust runners (46 and 48) are curved in opposing lateral directions. Therefore, the first exhaust runner 46 is curved in a negative lateral direction and the second exhaust runner 48 is curved in a positive lateral direction. The positive lateral direction is the direction extending toward the top of the drawing sheet. The lateral axis 292 and a longitudinal axis 310 are provided for reference. The exhaust runners are curved in this way to accommodate for the direct fuel injector 44. However, other exhaust runner geometries have been contemplated. For example, one exhaust runner may be curved while the other exhaust runner is substantially straight or both of the exhaust runners may be straight.

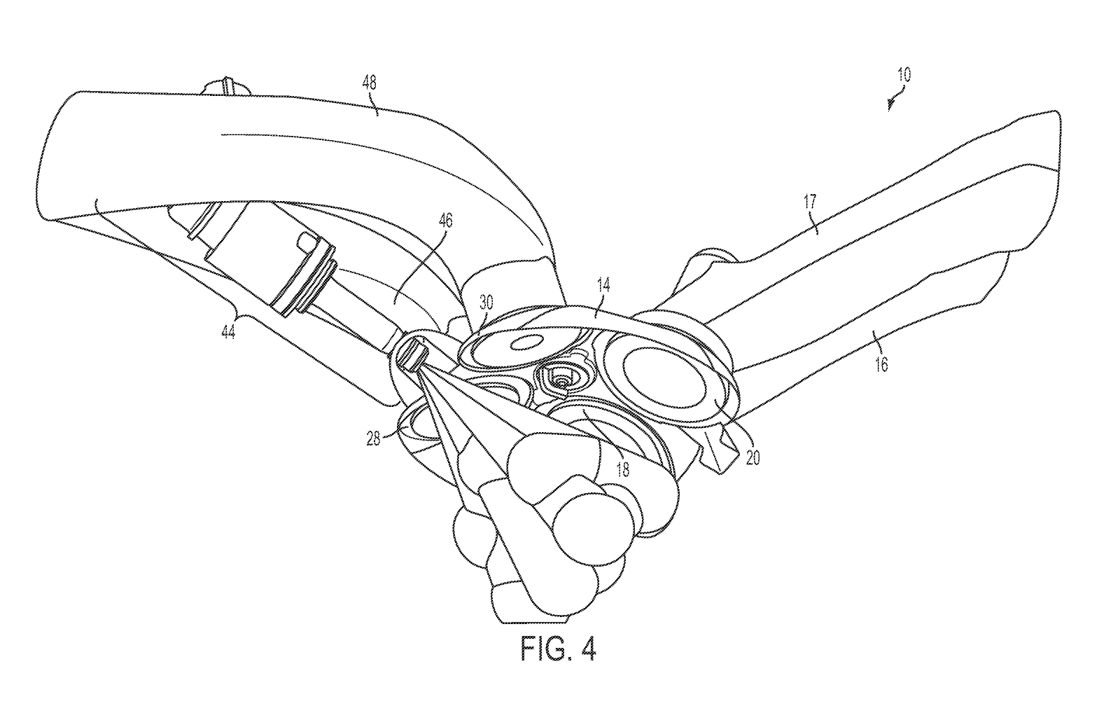

FIG. 4 shows another view of the engine 10 including the cylinder head 14. It will be appreciated that the cylinder block 202 is not shown in FIG. 4 but may be coupled to the cylinder head 14 and included in the engine 10. The direct fuel injector 44, the first intake port 18, the second intake port 20, the first exhaust port 28, and the second exhaust port 30 are also shown. Furthermore, the first intake runner 16, the second intake runner 17, the first exhaust runner 46, and the second exhaust runner 48 are also shown.

It will be appreciated that the configurations and routines disclosed herein are exemplary in nature, and that these specific embodiments are not to be considered in a limiting sense, because numerous variations are possible. For example, multi-cylinder inline engines, V-engines, and horizontally opposed engines operating in natural gas, gasoline, diesel, or alternative fuel configurations could use the present description to advantage. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system comprising:
a combustion chamber;
a first exhaust port in fluidic communication with the combustion chamber;
a second exhaust port in fluidic communication with the combustion chamber; and
a direct fuel injector positioned between the first and second exhaust port and fluidly communicating directly with the combustion chamber.

2. The system of claim 1, where the first exhaust port and the second exhaust port are both in direct fluidic communication with the combustion chamber.

3. The system of claim 1, further comprising a first exhaust runner in direct fluidic communication with the first exhaust port and a second exhaust runner in direct fluidic communication with the second exhaust port, the first and second exhaust runners converging at a confluence point, the first exhaust runner and the second exhaust runner have an unequal length.

4. The system of claim 3, where the first and second exhaust runners are curved in opposing directions.

5. The system of claim 1, where a first angle between a radial axis of the second exhaust port and a central axis of the combustion chamber is less than an second angle between a radial axis of an intake port and the central axis, the intake port in direct fluidic communication with the combustion chamber.

6. The system of claim 1, further comprising a piston at least partially positioned within the combustion chamber, the piston including a piston crown having its lowest point positioned on an exhaust side of the combustion chamber.

7. The system of claim 1, where the direct fuel injector includes a tip directing fuel spray into the combustion chamber in a direction at least partially opposing a flow of intake air through an intake port in direct fluidic communication with the combustion chamber.

8. The system of claim 7, where an axis of the tip forms an angle between 45 and 80 degrees with a central axis of the combustion chamber and a spray pattern from the tip diverges from the axis of the tip by greater than 30 degrees.

9. The system of claim 1, further comprising a cylinder head and a cylinder block coupled together forming the combustion chamber, the system further comprises a first exhaust runner in direct fluidic communication with the first exhaust port and a second exhaust runner in direct fluidic communication with the second exhaust port, the first and second exhaust runners included in an exhaust manifold integrated into the cylinder head.

10. The system of claim 9, further comprising a coolant passage traversing the cylinder head adjacent to the direct fuel injector.

11. The system of claim 9, where the direct fuel injector is positioned vertically below the first and second exhaust runners.

12. The system of claim 9, where a width of an intake bridge section included in the cylinder head is less than a width of an exhaust bridge section included in the cylinder head, the exhaust bridge section extending between the first and second exhaust ports and the intake bridge section extending between a first intake port and a second intake port, the first and second intake ports in direct fluidic communication with the combustion chamber.

13. The system of claim 1, where the direct fuel injector is positioned between a first exhaust runner and a second exhaust runner, the first exhaust runner in direct fluidic communication with the first exhaust port and the second exhaust runner in fluidic communication with the second exhaust port.

14. The system of claim 1, further comprising an intake port in direct fluidic communication with the combustion chamber and an ignition device positioned between the intake port and the first and second exhaust ports.

15. A system comprising:
a cylinder head coupled to a cylinder block forming a combustion chamber;
a first exhaust port in direct fluidic communication with the combustion chamber;
a second exhaust port in direct fluidic communication with the combustion chamber;
an exhaust manifold integrated into the cylinder including a first exhaust runner in direct fluidic communication with the first exhaust port and a second exhaust runner in direct fluidic communication with the second exhaust port; and
a direct fuel injector positioned between the first and second exhaust port and opposite to a first intake port and a second intake port, the first and second intake ports in fluidic communication with the combustion chamber.

16. The system of claim 15, where the direct fuel injector is positioned vertically below the first and second exhaust runners, and the direct fuel injection injector aiming at least partially toward an intake valve side of combustion chamber.

17. The system of claim 15, where the exhaust manifold further includes an outlet positioned on a side of the cylinder head, the outlet in fluidic communication with first exhaust runner and the second exhaust runner and the direct fuel injector extends through the side of the cylinder head.

18. The system of claim 15, further comprising a piston at least partially positioned within the combustion chamber, the piston including a piston crown having its lowest point positioned on an exhaust side of the combustion chamber.

19. A system comprising:
a cylinder head coupled to a cylinder block forming a combustion chamber;
a piston a piston at least partially positioned within the combustion chamber;
an intake port in direct fluidic communication with the combustion chamber;
a first exhaust port in direct fluidic communication with the combustion chamber;
a second exhaust port in direct fluidic communication with the combustion chamber;
an exhaust manifold integrated into the cylinder head including a first exhaust runner in direct fluidic communication with the first exhaust port and a second exhaust runner in direct fluidic communication with the second exhaust port; and
a direct fuel injector positioned between the first and second exhaust port and including a tip directing a fuel spray in a direction at least partially opposing a flow of intake air through the intake port.

20. The system of claim 19, where an axis of the tip forms an angle between 45 and 80 degrees with a central axis of the combustion chamber and a spray pattern from the tip diverges from the axis of the tip by greater than 30 degrees.

21. The system of claim 19, where a piston is positioned in the combustion chamber and includes a crown having its lowest point positioned on an exhaust side of the combustion chamber.
